(19) United States
(12) Patent Application Publication
(10) Pub. No.: US 2024/0278709 A1
(43) Pub. Date: Aug. 22, 2024

(54) POWERED CARGO TENSIONING DEVICE

(71) Applicant: Jesse Rasanen, Huntsville, TX (US)

(72) Inventor: Jesse Rasanen, Huntsville, TX (US)

(21) Appl. No.: 18/111,174

(22) Filed: Feb. 17, 2023

(51) Int. Cl. B60P 7/08

(52) U.S. Cl. CPC B60P 7/0861

(57) ABSTRACT

The powered cargo tensioning device may allow a user to secure a cargo using a mechanically powered and monitored force. Such a solution may comprise, for example, a motorized winch or pulley connected to a strap and a second attachment point to which a sender attached to the strap may be received. The winch or pulley may apply a tightening force to the strap that is controlled by a user but may utilize an amount of force in excess of which the user could normally apply. The device may further comprise a locking mechanism to prevent unwanted loosening of the strap, and may further comprise an alarm that notifies the user of unexpected loosening of the device. The device may further comprise a wireless controller or a dedicated software application for ease of use.

### TECHNICAL FIELD OF THE INVENTION

The present invention relates in general to tensioning devices, and, more specifically, to a powered cargo tensioning device.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

A flatbed is a type of storage area having a large, flat platform upon which cargo may be placed for transport. Flatbeds may be made from a variety of materials depending on their intended use, such as wood or steel, and are utilized in many variations and iterations including, for example, as pulled trailers, as railway rolling stock, and as a component of an automotive truck. Flatbed trucks, for example, generally comprise a cab enclosing a motor at their front and either a fixed or articulating flatbed at their rear. A pickup truck, similarly, comprises a cab enclosing a motor at its front and a bed at its rear, which essentially comprises a flatbed having, often, three raised sides and a tailgate. Depending on their scale or intended use, other vehicles may comprise variations on the flatbed or the bed concept, such as railway gondolas, dump trucks, and cargo aircraft.

Securing a load on a flatbed or within a bed is of crucial importance to the balance of the vehicle in question and the safety of the vehicle and the cargo. An unsecured load on a flatbed can fall from the vehicle during turning or acceleration, can crash into the cab during deceleration, and has even been responsible for crashing aircraft when loaded cargo shifted rearwards during takeoff. Within the walls of a bed such unrestrained cargo movement may even cause the vehicle to roll over or otherwise lose control as the walls of the bed attempt to restrain the unwanted movement of the cargo.

A number of mechanisms for securing cargo to a flatbed or bed are known in the art. One solution for securing wheeled cargo, for example, may involve the use of blocks, chocks, or wedges that prevent rotation of the wheels and, thus, restrain movement of the cargo in the direction that the wheels are pointed. Another solution for securing cargo may involve the use of locking mechanisms that have both a sender and a receiver, one attached to the cargo itself and one attached to the flatbed or bed, which may prevent the movement of cargo but also require the use of standardized cargo containers and transport devices. A solution often used supplementary to these mechanisms may be the addition of cargo netting, which may further assist in resisting the movement of cargo but is rarely used as a primary restraining mechanism due to the inherent flexibility of the netting design and material.

A well-known and widely used mechanism for securing cargo is the utilization of tie-down systems, which generally include a pair of attachment devices, a strap, and a mechanism for tightening the strap. In most common usage may be the ratcheting tie-down system, which comprises both a ratchet attached via a short length of strap to a hook and a long length of strap attached to a second hook. The first hook is looped into a first receiver, the long length of strap is passed through the ratchet, the second hook is looped into a second receiver, and the ratchet is utilized to tighten the strap and shorten the overall length of strap between the two receivers. When these two receivers are placed on either side of a cargo load on a flatbed or within a bed this mechanism serves to press the cargo against one of the available surfaces and limit its movement. A similar mechanism, often found on flatbed trailers, utilizes a crank and lever-arm system instead of a ratchet so that the user may apply more significant tightening force to the system.

A common issue in all of these systems is that they rely on user-applied force to tighten the securing mechanism the various devices and, often, this user-applied force may not be sufficient to secure the desired cargo. Thus, there is a need in the art for a powered cargo tensioning device that may allow a user to secure a cargo using a mechanically powered and monitored force. Such a solution may comprise, for example, a motorized winch or pulley connected to a strap and a second attachment point to which a sender attached to the strap may be received. The winch or pulley may apply a tightening force to the strap that is controlled by a user but may utilize an amount of force in excess of which the user could normally apply. The device may further comprise a locking mechanism to prevent unwanted loosening of the strap, and may further comprise an alarm that notifies the user of unexpected loosening of the device. The device may further comprise a wireless controller or a dedicated software application for ease of use. It is to these ends that the present invention has been developed.

### BRIEF SUMMARY OF THE INVENTION

To minimize the limitations in the prior art, and to minimize other limitations that will be apparent upon reading and understanding the present specification, the present invention describes a powered cargo tensioning device.

It is an objective of the present invention to provide a powered cargo tensioning device that may comprise strap sender assembly.

It is another objective of the present invention to provide a powered cargo tensioning device that may comprise a plurality of tracks.

It is another objective of the present invention to provide a powered cargo tensioning device that may comprise a winch.

It is another objective of the present invention to provide a powered cargo tensioning device that may comprise a winch bracket.

It is another objective of the present invention to provide a powered cargo tensioning device that may comprise a hook.

It is another objective of the present invention to provide a powered cargo tensioning device that may comprise a strap receiver assembly.

It is another objective of the present invention to provide a powered cargo tensioning device that may comprise a ring.

It is another objective of the present invention to provide a powered cargo tensioning device that may comprise a plurality of bracket bolts.

It is another objective of the present invention to provide a powered cargo tensioning device that may comprise a plurality of retainers.

It is another objective of the present invention to provide a powered cargo tensioning device that may comprise a plurality of compression springs.

It is another objective of the present invention to provide a powered cargo tensioning device that may comprise a plurality of retaining nuts.

It is another objective of the present invention to provide a powered cargo tensioning device that may comprise a motor.

It is another objective of the present invention to provide a powered cargo tensioning device that may comprise a spool.

It is another objective of the present invention to provide a powered cargo tensioning device that may comprise a strap.

It is another objective of the present invention to provide a powered cargo tensioning device that may comprise a locking solenoid.

It is another objective of the present invention to provide a powered cargo tensioning device that may comprise an alarm.

It is another objective of the present invention to provide a powered cargo tensioning device that may comprise a wireless remote.

It is another objective of the present invention to provide a powered cargo tensioning device that may comprise a wireless remote receiver.

It is another objective of the present invention to provide a powered cargo tensioning device that may comprise a software application.

It is another objective of the present invention to provide a powered cargo tensioning device that may comprise a resilient material of construction.

It is another objective of the present invention to provide a powered cargo tensioning device that may comprise a water-proof material of construction.

It is another objective of the present invention to provide a powered cargo tensioning device that may comprise a reusable material of construction.

It is another objective of the present invention to provide a powered cargo tensioning device that may comprise a washable material of construction.

It is another objective of the present invention to provide a powered cargo tensioning device that may comprise a multi-component construction.

It is another objective of the present invention to provide a powered cargo tensioning device that may comprise an antimicrobial layer.

It is another objective of the present invention to provide a powered cargo tensioning device that may comprise an antimicrobial material of construction.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 is a front isometric perspective view of a strap sender assembly of a powered cargo tensioning device, as contemplated by the present disclosure;

FIG. 2 is a front isometric perspective view of a strap sender assembly of a powered cargo tensioning device, as contemplated by the present disclosure;

FIG. 3 is a rear isometric perspective view of a strap sender assembly of a powered cargo tensioning device, as contemplated by the present disclosure;

FIG. 4 is a rear isometric perspective view of a strap sender assembly of a powered cargo tensioning device, as contemplated by the present disclosure;

FIG. 5 is a top elevation view of a strap sender assembly of a powered cargo tensioning device, as contemplated by the present disclosure;

FIG. 6 is a left side elevation view of a strap sender assembly of a powered cargo tensioning device, as contemplated by the present disclosure;

FIG. 7 is a right side elevation view of a strap sender assembly of a powered cargo tensioning device, as contemplated by the present disclosure;

FIG. 8 is a top plan view of a strap sender assembly of a powered cargo tensioning device, as contemplated by the present disclosure;

FIG. 9 is a bottom plan view of a strap sender assembly of a powered cargo tensioning device, as contemplated by the present disclosure;

FIG. 10 is an exploded component view of a strap sender assembly of a powered cargo tensioning device, as contemplated by the present disclosure;

FIG. 11 is an exploded component view of a winch assembly of a powered cargo tensioning device, as contemplated by the present disclosure;

FIG. 12 is an exploded component view of a strap receiver assembly of a powered cargo tensioning device, as contemplated by the present disclosure;

FIG. 13 is an overall view of a powered cargo tensioning device installed within an exemplary truck bed, as contemplated by the present disclosure;

FIG. 14 is an overall view of a powered cargo tensioning device installed within an exemplary truck bed, as contemplated by the present disclosure;

FIG. 15 is an overall view of a powered cargo tensioning device installed within an exemplary truck bed, as contemplated by the present disclosure; and

FIG. 16 is an isometric perspective view of a wireless controller of a powered cargo tensioning device, as contemplated by the present disclosure.

### DETAILED DESCRIPTION OF THE INVENTION

Certain terminology is used in the following description for reference only and is not limiting. The words “front,” “rear,” “anterior,” “posterior,” “lateral,” “medial,” “upper,” “lower,” “outer,” “inner,” and “interior” refer to directions toward and away from, respectively, the geometric center of the invention, and designated parts thereof, in accordance with the present disclosure. Unless specifically set forth herein, the terms “a,” “an,” and “the” are not limited to one element, but instead should be read as meaning “at least one.” The terminology includes the words noted above, derivatives thereof, and words of similar import.

The powered cargo tensioning device may allow a user to secure a cargo using a mechanically powered and monitored force. Such a solution may comprise, for example, a motorized winch or pulley connected to a strap and a second attachment point to which a sender attached to the strap may be received. The winch or pulley may apply a tightening force to the strap that is controlled by a user but may utilize an amount of force in excess of which the user could normally apply. The device may further comprise a locking mechanism to prevent unwanted loosening of the strap, and may further comprise an alarm that notifies the user of unexpected loosening of the device. The device may further comprise a wireless controller or a dedicated software application for ease of use.

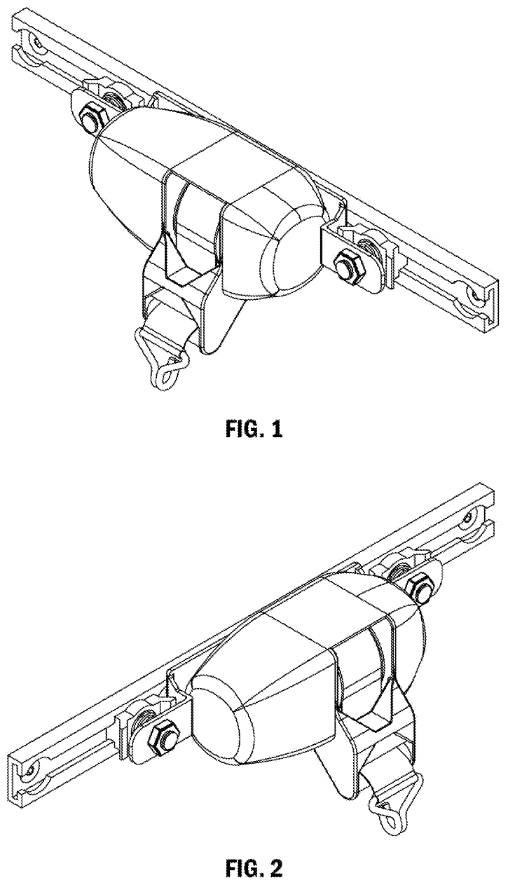

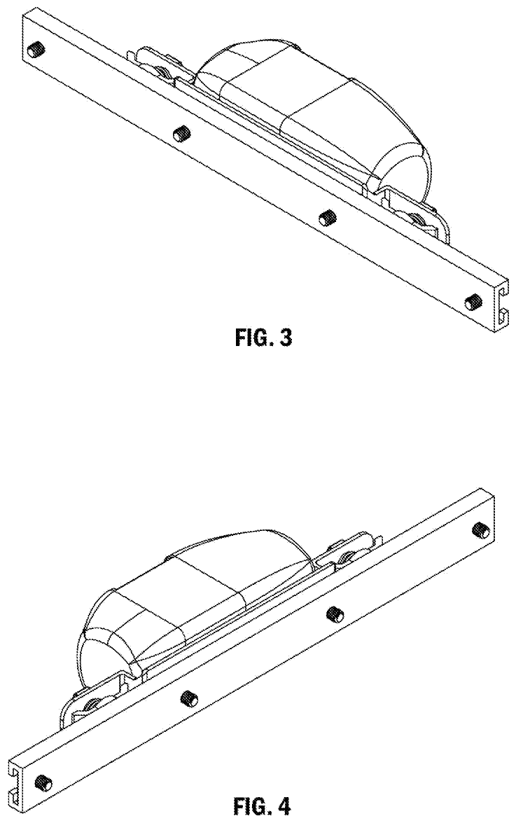

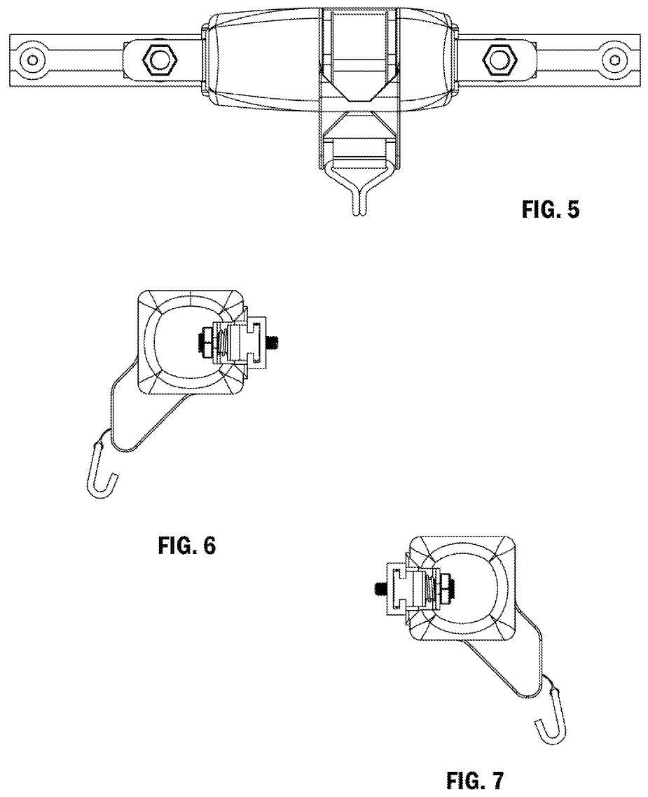

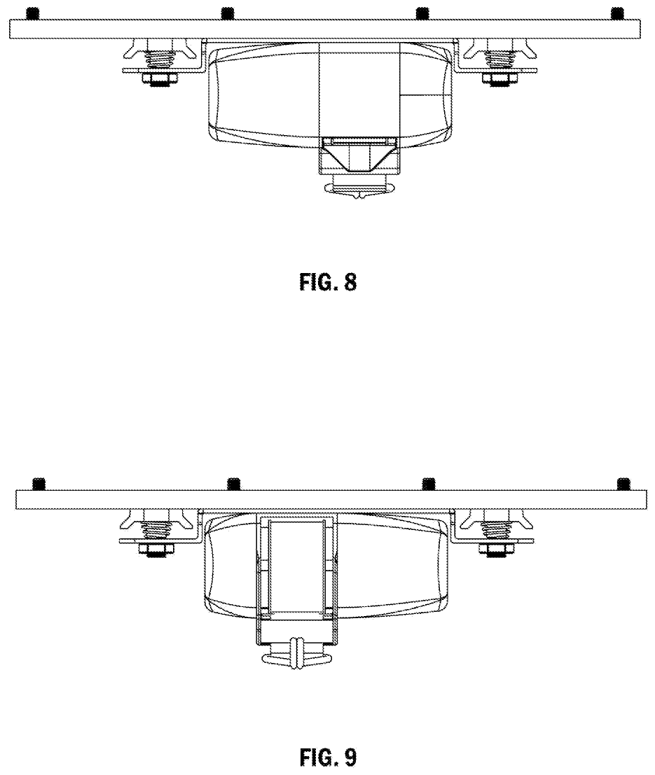

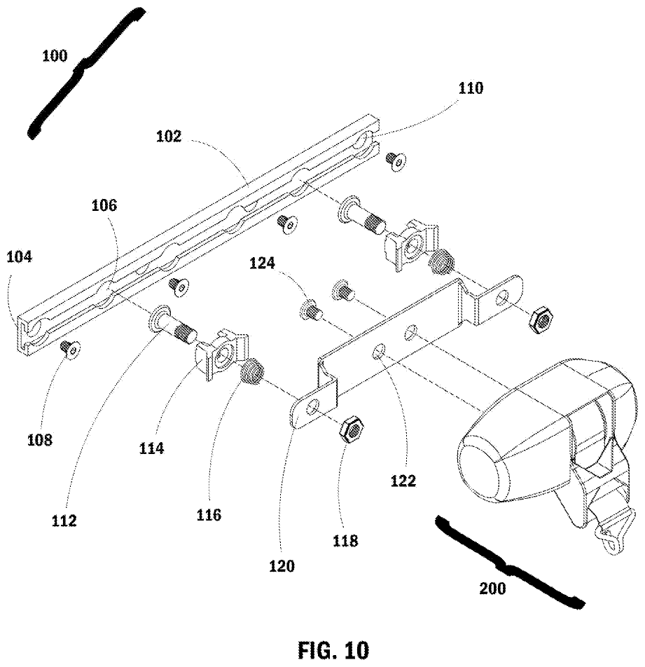

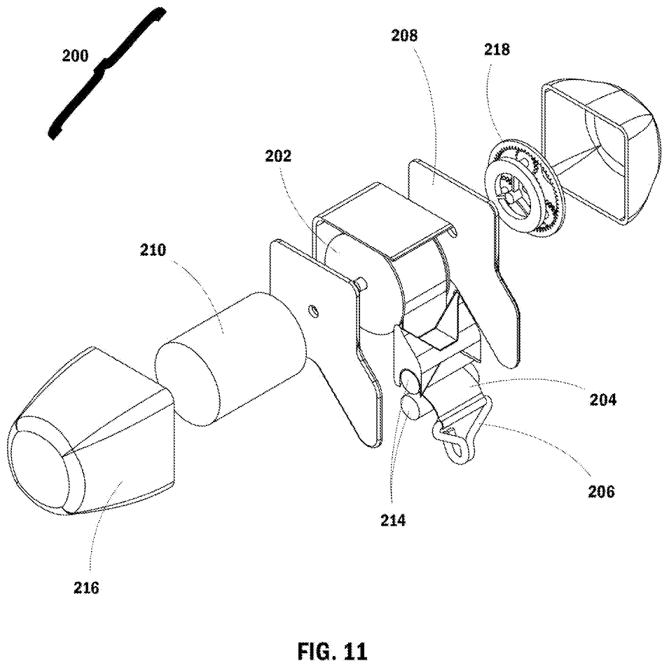

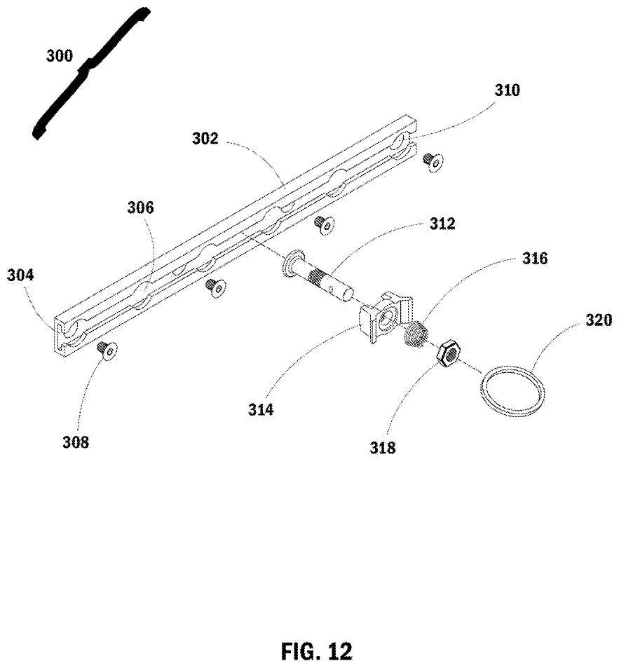

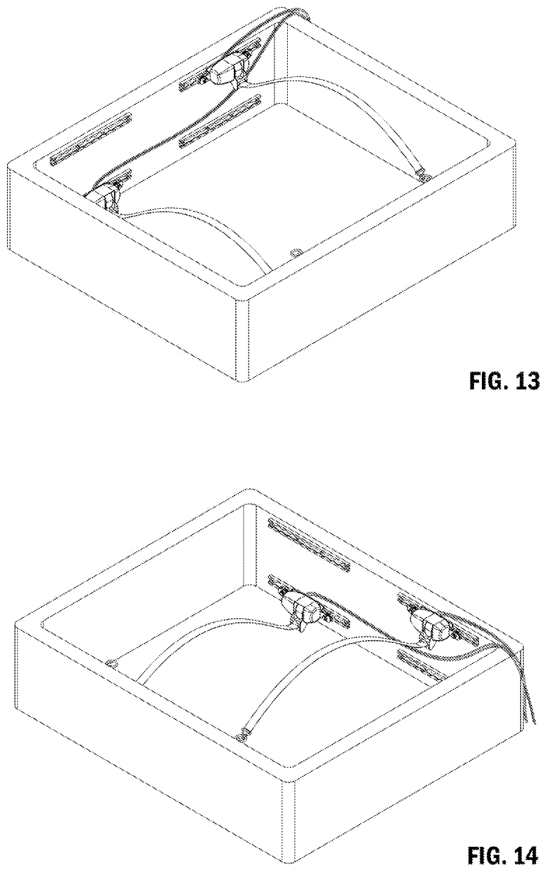

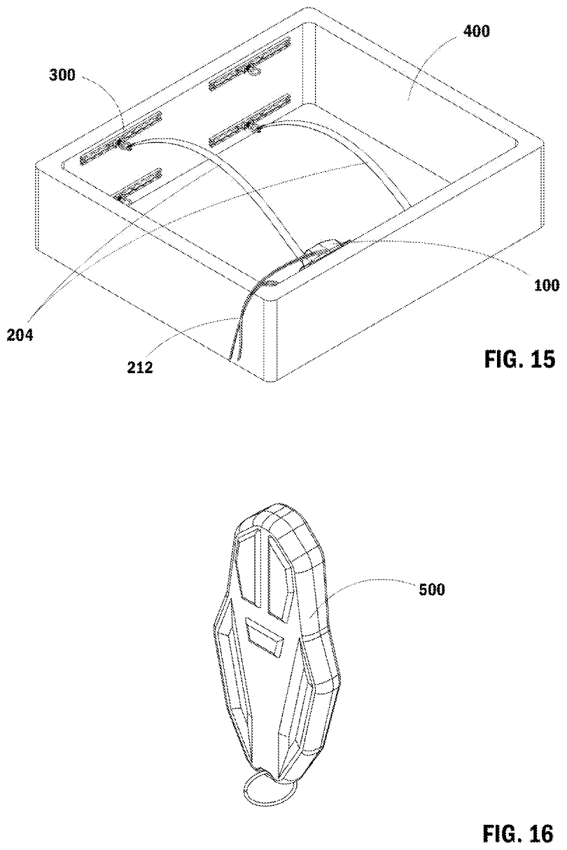

The illustrations of FIGS. 1-16 illustrate a powered cargo tensioning device, as contemplated by the present disclosure. The device may comprise, generally, a strap sender assembly 100 and a strap receiver assembly 300.

The strap sender assembly 100 may comprise, generally, a track 102 and a mechanism for attaching a strap 204 to the track 102. In one embodiment the track 102 may comprise a bracket having a track channel 104, a plurality of bracket bolt passages 106, and a plurality of track bolt passages 110. The track channel 104 may comprise an opening or a central cavity within the track 102 and the plurality of track bolt passages 110 may each comprise an opening in a back surface of the track 102. One each of a plurality of track bolts 108, which may comprise any appropriate bolt known in the art, may be inserted through one each of the plurality of track bolt passages 110 to attach the track 102 to an object.

The plurality of bracket bolt passages 106 may comprise enlarged or rounded openings in a front surface of the track 102 and may be connected to each other by a continuous opening in the front surface of the track 102. One each of a plurality of bracket bolts 112, which may comprise any appropriate bolt known in the art, may be inserted through any one of the plurality of bracket bolt passages 106 such that the head of the bracket bolt 112 is contained within the track channel 104 and the body of the bracket bolt 112 extends outward from the front surface of the track 102. One each of a plurality of retainers 114 may comprise a main body having a central opening and a plurality of notches, and may be slipped over one each of the bracket bolts 112 such that the body of the bracket bolt 112 passes through the central opening of the retainer 114 and the notches of the retainer 114 insert into the continuous opening in the front surface of the track 102.

The strap sender assembly may further comprise a bracket 120, which may comprise any appropriate bracket known in the art suitable for attaching a first component to a second component. In one embodiment the bracket 120 may further comprise a plurality of openings through one each of which may be inserted one each of the plurality of bracket bolts 112. One each of a plurality of retaining nuts 118, which may be compatible and complementary to one each of the plurality of bracket bolts 112 may be attached to couple the bracket 120 to the plurality of retainers 114 and, thus, the track 102. One each of a plurality of compression springs 116 may be inserted onto one each of the plurality of bracket bolts 112 between its respective retainer 114 and bracket 120 attachment to aid in locking the respective retaining nut 118 to the bracket bolt 112.

The bracket 120 may further comprise a plurality of winch bolt passages 122, which may comprise a plurality of openings in the bracket 120 through which one each of a plurality of winch bolts 124 may be inserted. The plurality of winch bolts 124 may then insert into any appropriate device, such as a winch 200, a strap 204, or a spool 202, thus attaching that device to the bracket 120 and the track 102.

The powered cargo tensioning device may further comprise a winch 200, which may generally comprise a drum or a spool 202 connected to a powered motor 210. The motor 210 may be electrically connected to a power source such as, for example, a vehicle battery, by an electrical connection 212, and may be physically connected to the drum or spool 202 by any appropriate physical connection such as, for example, an axle or a plurality of planetary gears. Activation of the electrical connection 212 may cause the motor 210 to generate a rotational torque that is applied to the drum or spool 202 to create a clockwise or counter-clockwise rotational movement in the drum or spool 202, as desired.

In an embodiment comprising a spool 202, the spool 202 may be physically attached to a first end of a strap 204, and the strap 204 may be wound around the spool 202. A second end of the strap 204 may be attached to a hook 206 or any other appropriate attachment mechanism. The clockwise or counter-clockwise rotational movement of the spool 202 induced by the motor 210 would, thus, serve to either wind or unwind the strap 204 from the spool 202, as desired.

In an embodiment comprising a drum these same principles described above would apply. The entirety of the components of the winch 200 may be mounted to a plurality of brackets 208 and enclosed within a housing 216.

Unique to the winch 200 of the powered cargo tensioning device may be that the winch 200 further comprises a plurality of rollers 214 through which the strap 204 is passed. The plurality of rollers 214 may comprise any appropriate rollers such as, for example, free-spooling drums or cylinders, that serve to prevent the undesired binding or folding of the strap 204 as it is wound or unwound from the spool 202. The plurality of rollers 214 may additionally serve to prevent over-winding of the strap 204 on the spool 202, as the hook 206 would be unable to pass through the plurality of rollers 214.

The winch 200 may further comprise a locking solenoid 218, which may comprise any solenoid, lock, bar, or other mechanism sufficient to prevent undesired unspooling of the strap 204 from the spool 202. In one embodiment the locking solenoid 218 may comprise a plurality of toothed gears having a drop latch that prevents reversed movement of the gears. In another embodiment the locking solenoid 218 may comprise a rod or axle that is passed through an opening in the spool 202 to prevent undesired rotation of the spool 202.

The winch 200 may further comprise an alarm, which may comprise any appropriate audible or visual alert sufficient to informing the user that a slippage has occurred in the spool 202, that a loosening of the strap 204 has occurred, or that the locking solenoid 218 has failed. The objective of the alarm is to detect when the powered cargo tensioning device has released tension on a cargo so that a user may take immediate remedial action and reduce risk to its vehicle or its load. The alarm may comprise any of a plurality of sensors that are triggered by unexpected movement in the spool 202, a decrease in tension of the strap 204, a release of the locking solenoid 218, or any other appropriate means. Examples of such sensors may include, for example, timing light devices, light detection and ranging devices, tension meters, torque meters, accelerometers, or any other device that may detect a change in position.

The appropriate audible or visual alert of the alarm may comprise any appropriate mechanism for notification such as, for example, projecting an audible sound, displaying a visible notification, or sending a notification through an appropriate software. In one embodiment the audible sound may be projected by the addition of one or more speakers built into the winch 200, which may project an alert when the alarm is triggered. In one embodiment the visual notification may be projected by the addition of one or more light bulbs or light-emitting diodes built into the winch 200, which may display an alert when the alarm is triggered. In one embodiment the audible sound or visual notification may be presented to a user through a speaker or a plurality of lights built into a wireless remote 500.

The strap receiver assembly 300 may comprise, generally, a track 302 and a mechanism for attaching a ring 320 to the track 302. In one embodiment the track 302 may comprise a bracket having a track channel 304, a plurality of bracket bolt passages 306, and a plurality of track bolt passages 310. The track channel 304 may comprise an opening or a central cavity within the track 302 and the plurality of track bolt passages 310 may each comprise an opening in a back surface of the track 302. One each of a plurality of track bolts 308, which may comprise any appropriate bolt known in the art, may be inserted through one each of the plurality of track bolt passages 310 to attach the track 302 to an object.

The plurality of bracket bolt passages 306 may comprise enlarged or rounded openings in a front surface of the track 302 and may be connected to each other by a continuous opening in the front surface of the track 302. One each of a plurality of ring bolts 312, which may comprise any appropriate bolt known in the art that also comprises an opening through the body of the ring bolt 312 perpendicular to its length, may be inserted through any one of the plurality of bracket bolt passages 306 such that the head of the ring bolt 312 is contained within the track channel 304 and the body of the ring bolt 312 extends outward from the front surface of the track 302. One each of a plurality of retainers 314 may comprise a main body having a central opening and a plurality of notches, and may be slipped over one each of the ring bolts 312 such that the body of the ring bolt 312 passes through the central opening of the retainer 314 and the notches of the retainer 314 insert into the continuous opening in the front surface of the track 302.

One each of a plurality of retaining nuts 318, which may be compatible and complementary to one each of the plurality of ring bolts 312 may be attached to couple the ring bolt 312 to the track 302. One each of a plurality of compression springs 316 may be inserted onto one each of the plurality of ring bolts 312 between its respective retainer 314 and retaining nut 318 to aid in locking the respective retaining nut 118 to the retainer 314. One each of the plurality of rings 320 may then be attached to one each of the plurality of ring bolts 312 by inserting the ring 320 into the opening through the body of the ring bolt 312 perpendicular to its length.

In one embodiment the powered cargo tensioning device may further comprise a control module, which may itself comprise a battery, a capacitor, and other electronic components appropriate to obtaining the objective of the control module. The control module may store and provide electrical power to the device and may receive a plurality of signals from a wireless remote 500. In one embodiment the control module may be wirelessly connected to a wireless remote 500 by a wireless remote receiver. The wireless remote 500 may provide a user with the ability to wirelessly control the motor 210 of the device. The wireless remote 500 may comprise a plurality of control buttons or levers that allow the user to independently control the clockwise or counter-clockwise rotational movement in the drum or spool 202, as desired.

In one embodiment the powered cargo tensioning device may further comprise a software application, which may comprise a proprietary downloadable software, that allows the user to control, monitor, and receive alerts from the powered cargo tensioning device.

To begin using the device a user may first install one or more of the strap sender assemblies 100 into a, for example, truck bed 400, and may then install one or more of the strap receiver assemblies 300 into the truck bed 400. The user may then place a cargo load within the truck bed 400, unwind the strap 204 from the strap sender assembly 100, and attach the hook 206 of the strap sender assembly 100 to the ring 320 of the strap receiver assembly 300. The user may then activate the motor 210 of the winch 200 to wind the strap 204 back into the strap sender assembly 100, effectively shortening the overall length of the strap 204 and tightening the strap 204 onto the cargo load into the truck bed 400.

The powered cargo tensioning device may be substantially constructed of any suitable material or combination of materials, but typically is constructed of a resilient material or combination of materials such that the device is resistant to damage as a result of compression, twisting, heating, or submersion in water. As an example, and without limiting the scope of the present invention, various exemplary embodiments of the powered cargo tensioning device may be substantially constructed of one or more materials of steel, aluminum, brass, fiberglass, carbon fiber, plastic, acrylic, polycarbonate, polyester, nylon, denim, cotton, silicone, or combinations thereof. In some embodiments the various components of the device may be coated, lined, or otherwise insulated to prevent contamination of the device. In one embodiment the material of construction may vary from one component to the next within the system.

In one embodiment the powered cargo tensioning device may comprise a resilient material of construction that either comprises a material having antimicrobial properties or comprises a layering of antimicrobial material or coating. Antimicrobial properties comprise the characteristic of being antibacterial, biocidal, microbicidal, anti-fungal, anti-viral, or other similar characteristics, and the oligodynamic effect, which is possessed by copper, brass, silver, gold, and several other metals and alloys, is one such characteristic. Copper and its alloys, in particular, have exceptional self-sanitizing effects. Silver also has this effect, and is less toxic to users than copper. Some materials, such as silver in its metallic form, may require the presence of moisture to activate the antimicrobial properties.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. A powered cargo tensioning device, comprising:
a strap sender assembly;
a strap receiver assembly; and
a winch;
wherein said strap sender assembly comprises a sender track, a bracket, and a sender connection mechanism;
wherein said sender connection mechanism comprises a plurality of bracket bolts, a plurality of retainers, and a plurality of retaining nuts;
wherein said strap receiver assembly comprises a receiver track; a plurality of rings; and
a receiver connection mechanism;
wherein said receiver connection mechanism comprises a plurality of ring bolts, a plurality of retainers, and a plurality of retaining nuts;
wherein said winch comprises a motor, a spool, a strap, and a hook;
wherein said motor is attached to said spool;
wherein said spool is attached to a first end of said strap;
wherein said hook is attached to a second end of said strap;
wherein said winch is attached to said bracket of said strap sender assembly.

2. The cargo tensioning device of claim 1, further comprising:
a winch housing;
wherein said winch is contained in said winch housing.

3. The cargo tensioning device of claim 2,
wherein one each of said plurality of retainers comprise a plurality of notches;
wherein said plurality of notches insert into a channel on a front surface of said sender track; and
wherein said plurality of notches insert into a channel on a front surface of said receiver track.

4. The cargo tensioning device of claim 3, further comprising:
an electrical connection;
wherein said electrical connection is electrically connected to a vehicle.

5. The cargo tensioning device of claim 4, further comprising:
a control module;
a wireless remote; and
a wireless remote receiver;
wherein said control module is electrically connected to said motor.
wherein said wireless remote receiver is attached to said control module; and
wherein said wireless remote is wirelessly connected to said wireless remote receiver.

6. The cargo tensioning device of claim 5, further comprising:
a locking solenoid;
wherein said locking solenoid is removably attached to said spool; and
wherein said locking solenoid prevents said spool from turning when engaged.

7. The cargo tensioning device of claim 6, further comprising:
an alarm;
wherein said alarm is activated by an undesired rotation of said spool; and
wherein said alarm provides an audiovisual alert to a user when activated.

8. The cargo tensioning device of claim 7, further comprising:
a software application;
wherein said software application displays a user interface to said user;
wherein said user interface receives a plurality of inputs from said user; and
wherein said user interface presents a plurality of outputs to said user.

9. A method of using a powered cargo tensioning device, comprising:
attaching a sender track to a truck bed;
attaching a receiver track to a truck bed opposite said sender track;
attaching a winch to said sender track;
attaching a receiver to said receiver track;
placing a cargo between said winch and said receiver;
unspooling a spool of strap from said winch;
passing said strap across said cargo;
connecting a hook attached to said strap to a ring attached to said receiver; and
spooling said strap back into said winch.

10. The method of claim 9, further comprising;
engaging a locking solenoid contained within said winch to prevent unspooling of said spool.

11. The method of claim 10;
wherein said unspooling and said spooling is performed with a wireless remote.

12. The method of claim 11;
wherein said unspooling and said spooling is performed with a software application.
